(19) United States
(12) Patent Application Publication
(10) Pub. No.: US 2010/0149912 A1
(43) Pub. Date: Jun. 17, 2010

(54) SYSTEM AND METHOD FOR REDUCING SIGNATURE VARIATION OF SEISMIC SOURCES

(76) Inventors: Luren Yang, Oslo (NO); Nicolae Moldoveanu, Houston, TX (US)

Correspondence Address: WesternGeco L.L.C.;Kevin McEnaney, IP Dept, 10001 Richmond Avenue, HOUSTON, TX, 77042-4299, US

(21) Appl. No.: 12/337,257

(22) Filed: Dec. 17, 2008

(51) Int. Cl. G01V 1/38

(52) U.S. Cl. 367/23

(57) ABSTRACT

A technique facilitates the reduction of seismic source signature variation during a seismic survey. The technique involves estimating an azimuth angle and/or a departure angle for one or more seismic source elements. The angles are used to determine adjustments, such as seismic source depth adjustments, able to reduce seismic source signature variation. The adjustments can be made prior to firing the one or more seismic source elements.

### BACKGROUND

In a variety of marine environments, seismic surveys are conducted to gain a better understanding of geological formations beneath a body of water. Marine seismic source arrays are used to generate acoustic pulses in the water, and hydrophones detect the reflected signals. The actuation or firing of the acoustic source elements is controlled by firing controllers. Upon firing an acoustic source, a resultant pressure pulse creates a seismic source signature that can be reflected off the underwater formations for receipt by the hydrophones.

Seismic source signatures vary with the azimuth angles and/or the departure angles relative to the seismic source. The azimuth angle is defined as the angle between the projection of a ray to a horizontal plane and an axis on the horizontal plane. The departure angle is defined as the angle between the ray and a vertical axis. Variations in azimuth angles and/or departure angles during a seismic survey cause corresponding variations in the seismic source signatures and, consequently, in the signal spectrum. Generally, the seismic source signature variation is unwanted in seismic surveys.

### SUMMARY

In general, the present invention provides a system and methodology for reducing signature variation of seismic sources. The system and methodology involve estimating an azimuth angle and/or a departure angle for one or more seismic source elements. The angles are used to determine system adjustments, such as seismic source depth adjustments, able to reduce seismic source signature variation. The adjustments are then made prior to firing the one or more seismic source elements.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of one example of a seismic survey system, according to an embodiment of the present invention;

FIG. 2 is a schematic view illustrating different departure angles between two seismic sources, according to an embodiment of the present invention;

FIG. 3 is a schematic representation of an example of a processor based control system for use in the seismic survey system, according to an embodiment of the present invention;

FIG. 4 is a schematic illustration of another example of a seismic survey system having a source cooperating with a plurality of receivers, according to an alternate embodiment of the present invention;

FIG. 5 is a schematic view illustrating different departure angles that result from a moving seismic source, according to an alternate embodiment of the present invention;

FIG. 6 is a diagram illustrating propagation of a signal resulting from a seismic event originating from a seismic source, according to an alternate embodiment of the present invention;

FIG. 7 is a diagram illustrating maximum departure angles that can be calculated by a three-dimensional ray tracing technique for a certain target horizon, according to an alternate embodiment of the present invention; and

FIG. 8 is a flowchart illustrating one example of an operational procedure for reducing signature variation of seismic sources, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a technique for reducing signature variation of seismic sources to improve the quality of the data collected during a seismic survey. Seismic sources and corresponding receivers, e.g. hydrophones, are deployed in a marine seismic survey area. Due to the relative locations of seismic sources and corresponding receivers and/or because of movement of the seismic sources or receivers, the azimuth angles and departure angles can differ. The different angles affect the accuracy and quality of the seismic data collected. According to one embodiment of the invention, the depth of specific seismic sources is adjusted to compensate the variation of the azimuth angles and departure angles so as to reduce seismic source signature variation and to improve the usefulness of the seismic data collected.

In some applications, the technique is applied to seismic sources having multiple seismic source elements in which each seismic source element is approximately an omni-directional source emitting nearly identical signals/signatures in all directions. The azimuth angle and the departure angle for each seismic source is estimated based on the seismic survey geometry, e.g. the location of seismic sources and receivers, and on the target, e.g. geological feature, location. The azimuth and departure angles can be used to determine a firing time for each seismic source element. If the seismic source has multiple source elements, the location of individual source elements also can affect the determined firing time. The angles, e.g. the departure angles, also can be used to establish a depth adjustment for each seismic source in a manner that reduces seismic source signature variation. After moving selected seismic sources to the desired depth, the seismic source elements can be fired according to the determined firing times.

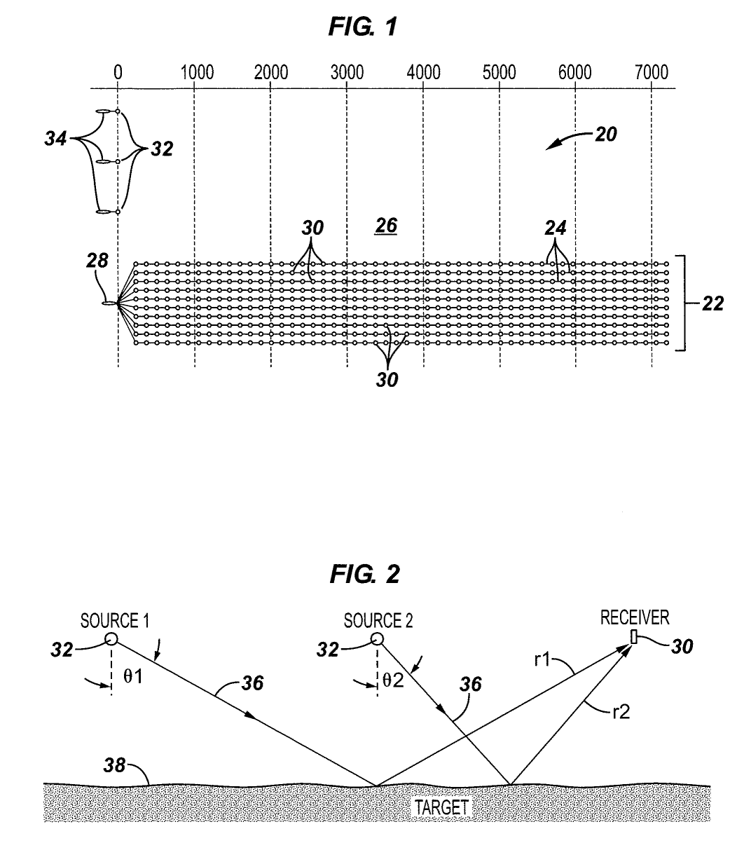

The determination of firing times and the depth adjustment of seismic sources can be employed in a variety of seismic survey systems. Referring generally to FIG. 1, for example, a seismic survey system 20 is illustrated according to one embodiment of the present invention. As illustrated, system 20 comprises a wide-azimuth, towed-streamer survey system having an array 22 formed of streamers 24 that are towed through a marine seismic survey area 26. The streamers 24 are towed by a streamer vessel 28 and contain multiple receivers 30, such as hydrophones. Additionally, a plurality of seismic sources 32 are employed, and those seismic sources 32 are positioned at different locations. By way of example, seismic sources 32 may be positioned on seismic source vessels 34, such as the three seismic source vessels illustrated.

Because the seismic sources 32 are positioned at different locations, the signals, e.g. acoustic signals, from these sources to the corresponding receivers 30 have different signatures due to the different azimuth and departure angles. The different azimuth angles and departure angles cause varying seismic source signatures and are illustrated schematically in FIG. 2. In this example, a pair of seismic sources 32 is illustrated along with an individual, corresponding receiver 30. An acoustic signal, as represented by directional lines 36, is provided by each seismic source 32. The signal is reflected off a target 38, e.g. a geological feature, and returned to receiver 30. The differing locations of the seismic sources 32 result in different departure angles, as illustrated by departure angles θ1 and θ2, respectively. Consequently, the spectra of the signals reflected to receiver 30, indicated by r1 and r2, respectively, are different even though the seismic sources 32 are identical. However, by adjusting the depth of seismic sources 32 and/or the firing times of the seismic sources, the source signature variation can be reduced or eliminated, as described in greater detail below.

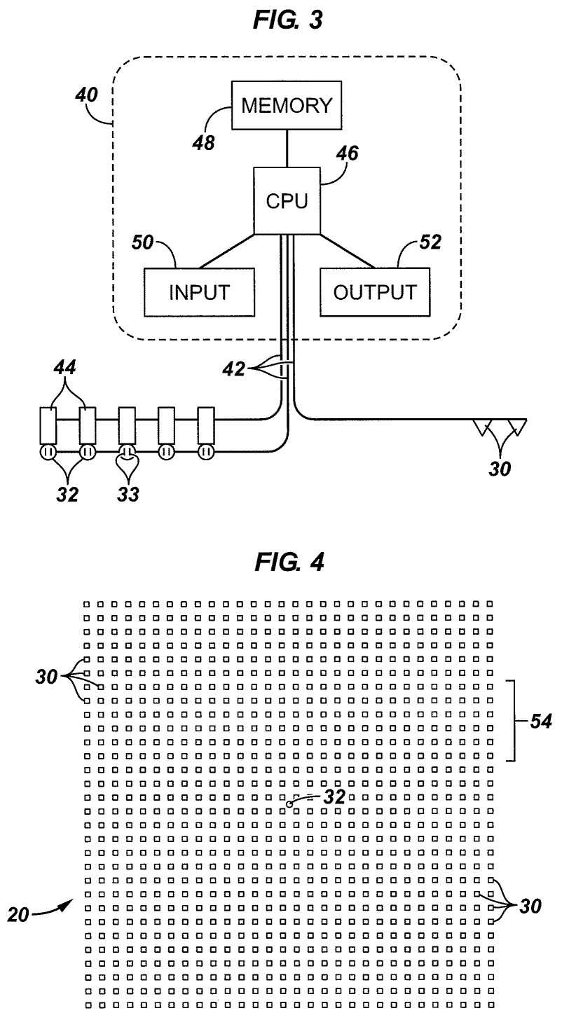

In many applications, the azimuth angles and departure angles can be processed on a suitable processor based control system, such as a computer control system, to determine depth adjustments and firing times. In FIG. 3, one example of a control system 40 is illustrated schematically. In this embodiment, control system 40 is connected to receivers 30 and seismic sources 32 via appropriate communication lines 42. By way of example, each seismic source 32 may comprise one or more acoustic source elements 33 and those source elements may be in the form of air guns designed to provide acoustic pulses into the marine seismic survey area 26.

The control system 40 also may be connected to one or more actuator mechanisms 44. Each actuator mechanism 44 is coupled to a corresponding seismic source 32 to move the seismic source to a desired depth in the marine seismic survey area. By way of example, actuator mechanisms 44 may comprise hydraulically, electrically or mechanically actuated winches, arms, levers, or other devices able to move the corresponding seismic source 32 to a desired depth as determined by control system 40. Depending on the configuration of seismic system 20, the actuator mechanisms 44 can be mounted to a variety of structures. For example, if seismic source vessels 34 are utilized, the actuator mechanisms 44 can be mounted to the seismic source vessels. The actuator mechanisms 44 also can be mounted on or under the buoy of the seismic sources. In many applications, control system 40 is used to automatically control actuator mechanisms 44 via one or more suitable communication lines 42. It should be noted that in many of these applications, communication lines 42 comprise, at least in part, wireless communication media.

Control system 40 may have a variety of forms and configurations and may be located on suitable surface vessels, e.g. surface vessels 28, 34, or at other appropriate locations depending on the seismic survey system equipment and environment. By way of example, control system 40 comprises an automated processing system, such as a computer-based system having a central processing unit (CPU) 46. CPU 46 may be operatively coupled to seismic sources 32, receivers 30, and/or actuator mechanisms 44. Additionally, the CPU 46 may be operatively coupled to a memory 48, an input device 50, and an output device 52. Input device 50 may comprise a variety of devices, such as a keyboard, mouse, voice-recognition unit, touchscreen, or other input devices or combinations of such devices. Output device 52 may comprise a visual and/or audio output device, such as a monitor having a graphical user interface. Additionally, the processing of data that is input into control system 40 and/or obtained from receivers 30 or other instruments may be performed on a single device or multiple devices located in the survey area or remote from the survey area.

Control system 40 is useful for determine firing times and seismic source depths for streamer array systems such as the system illustrated in FIG. 1. However, the technique can be applied to a variety of seismic survey applications. For example, the technique can be utilized in ocean bottom cable (OBC) surveys or ocean bottom seismometer (OBS) surveys. In these examples, the seismic source 32 is located in the middle of a spread 54 of receivers 30, as illustrated in FIG. 4. In this type of seismic system 20, the azimuth angle from seismic source 32 to receivers 30 can vary from zero to 360 degrees, and the departure angle can vary from vertical to an oblique angle. Again, control system 40 is employed to determine firing times and/or the depth adjustment of one or more seismic sources to control the departure and azimuth angles in a manner that facilitates seismic data collection via receivers 30.

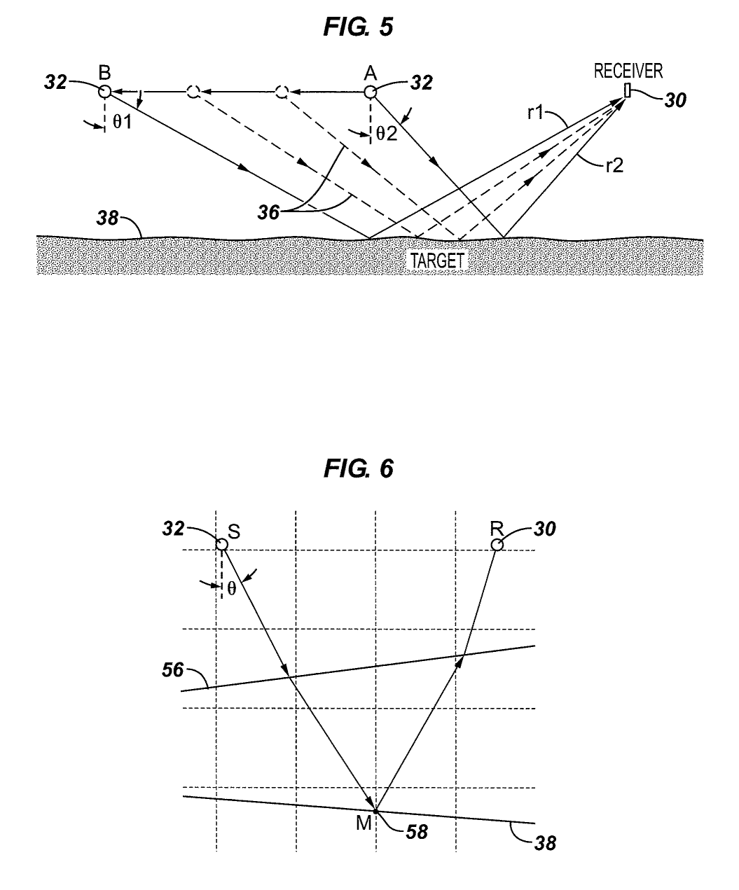

In another example, seismic source signature variation results from movement of the seismic source 32 and/or the corresponding receiver 30. The relative motion between the seismic source 32 and the receiver 30 causes a source signature variation over time, as illustrated by the diagram of FIG. 5. Referring generally to FIG. 5, as the seismic source 32 is moved relative to receiver 30 from position A to position B, the departure angle changes from θ2 to θ1. The change in departure angle causes a variation of the signal spectrum over time. As described with respect to previous embodiments, the signature variation can be reduced or eliminated by adjusting firing times and the depth of the seismic source 32 as it moves relative to receiver 30.

By way of example, control system 40 may be used to analyze and determine desired firing times for individual source elements by processing acquired data according to appropriate algorithms. According to one embodiment, the firing time tᵢ can be determined for each source element i by:

$${t}_{i} = \frac{\vert {[ \begin{matrix}{x}_{i} & {y}_{i} & {z}_{i}\end{matrix} ] [ \begin{matrix}A & B & 1\end{matrix} ]}^{T} \vert}{c \sqrt{{A}^{2} + {B}^{2} + 1}}$$

where

A=tan θ cos α

and

B=tan θ sin α

In this example, θ is the departure angle of the source, α is the azimuth angle of the source, c is the sound velocity, and [xᵢ yᵢ zᵢ] is the x, y, and z coordinate of the source element i, indicating the relative position of the source element within the seismic source 32. In this application, the relative firing times of source elements within a given seismic source 32 can be more useful than the absolute value of the firing time tᵢ. If we assume the source element i in a source has the smallest firing time value tᵢ, then this source element should be fired first. Any other source element j should be fired by a time delay tⱼ-tᵢ.

In a seismic system where all sources 32 in the seismic survey have the same nominal depth d, the depth of specific seismic sources is adjusted to account for variations in departure angle in a manner that minimizes seismic source variation. The nominal depth is adjusted according to the estimated departure angle, and the adjusted depth d′ is given by:

$${d}^{′} = \frac{2 d cos θ}{1 + cos θ}$$

The control system 40 can be used to process the absolute times, time delays, and adjusted depths d′ for seismic sources 32.

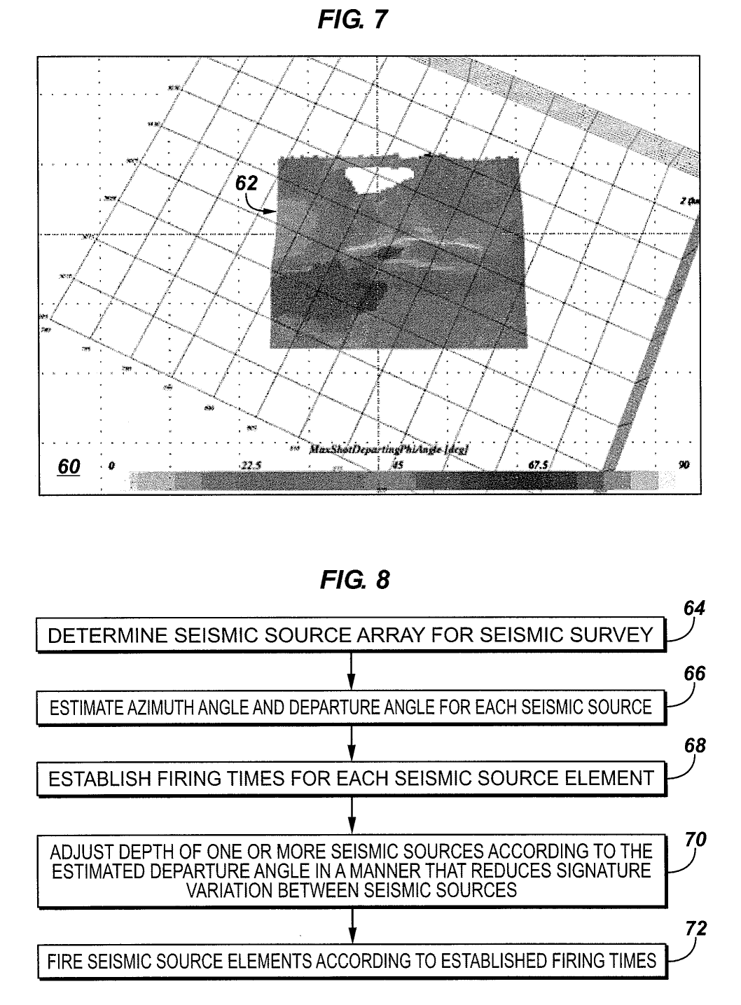

The azimuth angle α can be determined, e.g. calculated, via the control system 40 based on locations of the seismic sources 32 and corresponding receivers 30. In some applications, the departure angle for each seismic source and receiver location can be determined by three-dimensional ray tracing that utilizes a velocity depth model for the seismic survey area 26. An example of a ray tracing technique can be described with reference to FIGS. 6 and 7.

Referring generally to FIG. 6, a departure angle θ is illustrated as corresponding to a seismic event, e.g. a pressure pulse, originated from a specific seismic source 32. The acoustic signal propagates through a subsurface 56; is reflected from target 38 at a reflection point 58; and propagates back to the surface for recording at receiver 30. The departure angle is readily calculated based on these locations in combination with a suitable velocity depth model for the seismic survey area.

In FIG. 7, an example of a graphical output 60 is illustrated as showing the maximum departure angles 62 corresponding to a certain subsurface horizon. An output device, such as output device 52 of control system 40, can be used to display such data after determining the departure angles by processing location and modeling data on CPU 46. Such ray tracing calculations can be performed by control system 40 or other suitable control systems in advance to obtain information regarding the variation of departure angle for a specific seismic area. The data also can be processed to estimate an average value of the departure angle for use during seismic data acquisition.

For example, in many applications it may be useful to use average azimuth and departure angles based on the azimuth and departure angles from select groups of seismic sources and receivers within a given seismic array. In other applications, average azimuth and departure angles can be used when the azimuth and departure angles vary over time. When the variation over time does not cause significant seismic signature variation and/or when a less precise evaluation is acceptable, average angle values can be used to simplify the processing operation. In other applications, many different azimuth and departure angles exist simultaneously. For example, the seismic system 20 may utilize multiple receivers that effectively create multiple azimuth and departure angles relative to specific sources. When the differences between multiple receivers is not substantial and/or when a less precise evaluation is acceptable, average values for azimuth angles and departure angles can be used for specific groupings of angles.

The averaging of departure angles and azimuth angles is helpful in a variety of environments and applications that create relatively large numbers of different azimuth and departure angles. In some seismic systems 20, thousands of receivers 30 can be used in conducting a seismic survey. Acoustic signals from an individual seismic source 32 create large numbers of different azimuth and departure angles. The angles can sometimes be averaged over specific areas or groups of receivers to simplify the data processing without causing significant signal variation.

In other applications, the depth and slope of a subsurface can vary over time during a seismic survey, and this variation causes the departure angle to vary over time. However, the depth and slope variations often are relatively insubstantial, and an average departure angle can be utilized without substantially affecting the ability of the system 20 to reduce signature variation of the seismic sources.

Averaging of azimuth angles and departure angles also can be beneficial for applications and systems in which dynamic adjustment of the firing times and the seismic source depths is difficult. For example, depending on the system utilized for conducting the survey, dynamic adjustment of an array depth, e.g. seismic sources depth, during a seismic survey can be difficult. In some of these situations, an average departure angle may be used as an alternative to at least reduce seismic source signature variation. Averaging of departure angles and azimuth angles also can be conducted for specific subgroups of receivers 30 and corresponding seismic sources 32 to help improve reduction in signature variation as compared to using an average over the entire group.

The systems and methodology for reducing signature variation of seismic sources can differ from one seismic survey application to another. However, one operational example is illustrated by the flowchart of FIG. 8. In this example, the components and geometry of a seismic source array are initially determined for a specific seismic survey, as illustrated by block 64. Subsequently, an azimuth angle and a departure angle are estimated for one or more seismic sources 32, as illustrated by block 66. In some applications, the azimuth angle and departure angle used in the process may comprise average angles or other selected angles representative of specific groups of azimuth angles and/or departure angles.

Once the azimuth and departure angles are determined, firing times for each seismic source element 33 can be established, as represented by block 68. For example, the firing times can be calculated via control system 40 according to predetermined formulas or algorithms, as discussed above. Additionally, the departure angle also is used in establishing an appropriate depth adjustment for one or more of the seismic sources 32. The depth adjustment is selected to compensate the effect of the variation of the departure angle in a manner that reduces signature variation between seismic sources, as indicated by block 70. Upon selecting the firing times and adjusting seismic source depth, the seismic source elements are fired according to the established firing times, as indicated by block 72. The adjustment to depths and firing times reduces the signature variation between seismic sources 32 to optimize the seismic data obtained by receivers 30. Consequently, the seismic survey results are improved.

The examples discussed above are just a few of the configurations and procedures that can be used to reduce signature variation of seismic sources. For example, the number and arrangement of acoustic sources as well as the number and arrangement of receivers, e.g. hydrophones, can vary from one application to another. Similarly, the type of control system and the location of the control system can be adapted to specific equipment and/or applications. Furthermore, the actuator mechanisms used to adjust seismic source depth can be automated and may comprise a variety of structures and mechanisms. In some applications, the actuator mechanisms are operatively connected to the control system to enable automation of seismic source depth adjustment. The models, algorithms and formulas also can be adjusted according to the environment and the equipment utilized to facilitate determination of optimal firing times and seismic source depths. Different strategies also can be used for averaging azimuth angles and/or departure angles over groups of seismic sources and receivers.

Although only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A method of reducing signature variation of seismic sources, comprising:
estimating an azimuth angle and a departure angle for a plurality of seismic source elements;
determining a firing time for each seismic source element;
using the departure angle to determine a depth adjustment for each seismic source to reduce signature variation; and
adjusting the depth of at least one seismic source element.

2. The method as recited in claim 1, further comprising firing the plurality of seismic source elements.

3. The method as recited in claim 2, wherein firing comprises firing the seismic source elements at slightly different times.

4. The method as recited in claim 3, wherein determining comprises using the azimuth angle and the departure angle to determine the firing times.

5. The method as recited in claim 1, wherein estimating comprises estimating a departure angle with a ray tracing technique.

6. The method as recited in claim 1, wherein estimating comprises determining an average azimuth angle and an average departure angle over time.

7. The method as recited in claim 1, wherein estimating comprises using an average azimuth angle and average departure angle based on the azimuth angles and the departure angles of a group of seismic sources and/or receivers.

8. The method as recited in claim 1, wherein estimating comprises estimating azimuth angles and departure angles for multiple seismic sources in a wide azimuth towed streamer array when the multiple seismic sources are at unique locations relative to a receiver.

9. The method as recited in claim 1, wherein estimating comprises estimating azimuth angles and departure angles for ocean bottom cable surveys.

10. The method as recited in claim 1, wherein estimating comprises estimating azimuth angles and departure angles for ocean bottom seismometer surveys.

11. The method as recited in claim 1, wherein estimating comprises estimating azimuth angles and departure angles for a moving seismic source.

12. A method, comprising:
deploying a seismic source element and a receiver in a marine seismic survey area; and
adjusting the depth of the seismic source element to compensate the variation of an azimuth angle and a departure angle to improve data collection during a seismic survey.

13. The method as recited in claim 12, wherein deploying comprises deploying a plurality of seismic source elements and a plurality of hydrophones.

14. The method as recited in claim 13, further comprising computing a unique firing time for each seismic source element based on the azimuth angle and the departure angle.

15. The method as recited in claim 12, further comprising firing the seismic source elements, and conducting a seismic survey in the marine seismic survey area.

16. The method as recited in claim 12, further comprising combining a plurality of azimuth angles into a single representative angle for use in determining the desired depth of a seismic source element.

17. A system, comprising:
a seismic survey array having at least one seismic source element;
a mechanism to adjust the depth of the at least one source element; and
a control system operating to determine a depth value for the source element to reduce seismic source signature variations, the control system determining the depth value based on at least one of the azimuth and the departure angles relative to the seismic source element.

18. The system as recited in claim 17, wherein the at least one seismic source element comprises a plurality of seismic source elements.

19. The system as recited in claim 17, wherein the at least one seismic source element comprises a plurality of seismic source elements deployed in a towed streamer array.

20. The system as recited in claim 17, wherein the control system is a computer-based control system for processing azimuth angles and departure angles from a plurality of seismic source elements positioned in different locations.

21. The system as recited in claim 17, wherein the control system processes azimuth angles and departure angles between at least one seismic source element used in cooperation with a plurality receivers.

22. The system as recited in claim 17, wherein the control system processes azimuth angles and departure angles that result from a moving seismic source element.
